(19) United States
(12) Patent Application Publication
(10) Pub. No.: US 2023/0376022 A1
(43) Pub. Date: Nov. 23, 2023

(54) METHOD FOR OPERATING A MACHINE IN A PROCESSING PLANT FOR CONTAINERS AND MACHINE FOR HANDLING CONTAINERS

(71) Applicant: Krones AG, Neutraubling (DE)

(72) Inventor: Benedikt BOETTCHER, Bruckmühl (DE)

(21) Appl. No.: 18/248,366

(22) PCT Filed: Aug. 13, 2021
(86) PCT No.: PCT/EP2021/072601

§ 371 Date: Apr. 7, 2023

(30) Foreign Application Priority Data
Oct. 8, 2022 (DE) 102020126355.4

(51) Int. Cl. G05B 19/418; B67C 3/00; B67C 7/00; B65B 21/00

(52) U.S. Cl. CPC G05B 19/41885; B67C 3/007; B67C 7/004; B65B 21/00; G05B 2219/45054; B67C 2003/227

(57) ABSTRACT

A method for operating a machine in a processing plant for containers, in particular beverage containers, wherein the containers are processed and/or transported by the machine, wherein at least one input signal and at least one output signal of the machine are acquired during the processing and/or the transport, wherein a self-identification model of the machine, which model reproduces at least one current operating point of the machine, is determined based on the at least one input signal and the at least one output signal, wherein at least one machine parameter of the machine and/or of a downstream machine is automatically configured or optimised using the self-identification model, and/or wherein a diagnosis of the machine is automatically carried out using the self-identification model.

### CROSS-REFERENCE TO RELATED APPLICATIONS

This application is a 371 National Stage of International Application No. PCT/EP2021/072601, filed Aug. 13, 2021, which claims priority to German Patent Application No. 10 2020 126 355.4, filed Oct. 8, 2020, the disclosures of which are herein incorporated by reference in their entirety.

### TECHNICAL FIELD

The invention relates to a method for operating a machine in a processing plant for containers and to a machine for handling containers.

### BACKGROUND

Usually, such processes and machines are used to process and/or transport containers. For example, such a machine may be a container making machine, a filler, a capper, a rinser, a labeller, a container inspection machine, a direct printing machine, a conveyor, a palletiser, a packaging machine, a robot, an autonomous transport vehicle and/or a pump operated in the processing plant, in particular in a drinks processing plant. In such processes, containers are usually produced, filled with a flowable product, closed, transported and/or packaged as bundles. The flowable product may be, for example, a food product such as a drink. However, liquid medicines, cosmetics or cleaning products are also conceivable.

Usually, machine parameters of such machines are set during commissioning or retooling to a specific container type and then not changed during operation.

The disadvantage here is that the machine parameters refer to an operating state of the machine during commissioning or retooling, but the behaviour of the machine can change, for example due to wear or a changed mass flow. This can lead to deviations of the current operating point from the desired target behaviour, so that the machine works less efficiently.

WO 2017/186708 A1 discloses a method for optimising the filling of a container, wherein the set filling parameter is varied based on an algorithm to optimise a total filling time. A self-learning algorithm is proposed as an algorithm, in which self-learning structures in the manner of a neural network are provided.

This method also has the disadvantage that the calculation and optimisation is carried out before changing to a new product and that the current operating point of the machine is not taken into account. Furthermore, such a self-learning algorithm requires high computing power.

### SUMMARY

The object of the present invention is therefore to provide a method for operating a machine in a processing plant for containers and a machine for handling containers which operate more efficiently and reliably.

To solve this object, the invention provides a method for operating a machine in a processing plant for containers. Advantageous embodiments of the invention are specified.

By acquiring the at least one input signal and the at least one output signal of the machine during the processing and/or the transport and determining the self-identification model of the machine based thereon, which represents the at least one current operating point of the machine, the real behaviour of the machine at the current operating point can be modelled in the self-identification model. Thus, the self-identification model reflects, for example, wear occurring after commissioning or retooling accordingly. By automatically configuring or optimising the at least one machine parameter of the machine and/or the downstream machine using the self-identification model, the current operating point of the machine can be taken into account accordingly. Additionally or alternatively, a diagnosis of the machine may automatically be carried out using the self-identification model. This can be used, for example, to determine whether the wear exceeds a permissible level and a maintenance needs to be carried out.

The method may be carried out in a processing plant. The processing plant may comprise or consist of a drinks processing plant. Using such processing plants, containers are usually produced, filled with a flowable product, closed, transported and/or packaged as bundles. The flowable product may be, for example, a food product such as a drink. However, cosmetics or cleaning products are also conceivable.

Containers may be configured to receive drinks, food, hygiene products, pastes, chemical, biological and/or pharmaceutical products. The containers may be bottles, especially plastic bottles, glass bottles or (metal) cans. Plastic bottles may be in particular PET, PEN, HD-PE or PP bottles. The containers may also be biodegradable containers or bottles whose main components consist of renewable raw materials, such as sugar cane, wheat or maize. It is conceivable that the containers are provided with a closure.

The machine may be a container making machine, a filler, a capper, a rinser, a labeller, a container inspection machine, a direct printing machine, a conveyor, a palletiser, a packaging machine, a robot, an autonomous transport vehicle and/or a pump. The machine may comprise a processing unit and/or a transport unit to process and/or transport the containers. It is also conceivable that the machine comprises a vehicle for transporting the containers and/or tooling components of the machine, in particular an autonomously driving vehicle.

“Processing the containers” may include that the containers are manufactured, cleaned, filled, closed, labelled, inspected, provided with a direct print, arranged on a transport pallet and/or packaged into a bundle. “Transport of the containers” may include that the containers are transported from an upstream machine to the machine. This may also include that the containers are transported from the machine to a downstream machine.

The at least one input signal and/or the at least one output signal may comprise an analogue or digital electrical signal, for example from a sensor, an input unit and/or from a machine control. For example, the at least one input signal may comprise a predetermined, temporal course of an electric current for a drive and the at least one output signal may comprise the electric signal of an acceleration sensor with which a movement curve of the machine is acquired during the transport of the containers. It is also conceivable that the at least one input signal comprises a control characteristic. The control characteristic may, for example, be available as digital data in a computer system, in particular a machine control system of the machine. In other words, values may be predetermined for the machine with the at least one input signal in order to control the processing and/or the transport. Accordingly, the at least one output signal may be used to acquire values for the reaction of the machine to the at least one input signal. The at least one input signal and/or the at least one output signal may comprise time-dependent values.

The self-identification model may be a mathematical model to represent the transfer behaviour of the at least one input signal to the at least one output signal. Preferably, the self-identification model may be configured to predict a change in the at least one output signal based on a change in the at least one input signal. For example, the at least one output signal may be modified by the at least one machine parameter. This enables predicting the effect of a change in the at least one machine parameter on the behaviour of the machine.

The “current operating point of the machine” may be an operating state during the processing and/or the transport of the containers. For example, it may be an operating state during processing of a particular type of container. It is also conceivable that the processing and/or the transport of a specific container stream is meant.

During configuration or optimisation, at least one input value for the self-identification model of the machine may be determined with an initial value of the at least one machine parameter. Then, using the self-identification model, at least one output value may be determined from it that predicts the behaviour of the machine. Subsequently, the at least one machine parameter may be varied in such a way that the machine shows a desired or optimised behaviour.

It is also conceivable that using the self-identification model, the diagnosis of the machine is carried out automatically. For example, at least one characteristic value of the machine may be determined from the self-identification model to enable a conclusion regarding a type of fault or a sign of wear at the current operating point.

The self-identification model may be determined continuously during the operation of the machine. This enables continuously creating a digital image of the machine, ensuring that the at least one machine parameter and/or the diagnosis of the machine are always up-to-date. Thus, it is also possible to react to short-term changes in the operating point of the machine. The at least one input signal and the at least one output signal may be acquired continuously. It is also conceivable that the self-identification model is continuously acquired in order to reproduce different operating points of the machine.

The self-identification model may comprise one or more self-identification equations, in particular a linear inhomogeneous differential equation and/or a difference equation. Thus, the self-identification model can be determined in a particular easy way. For example, the linear inhomogeneous differential equation may have the form

b₃* [symbol] +b₂*ÿ+b₁*\dot{y}+b₀*y=a₀*u (1)

where y comprises the at least one input signal and u comprises the at least one output signal, and where b₀, b₁, b₂, b₃ and a₀ are coefficients of the linear inhomogeneous differential equation determined in the determination of the self-identification model. The determination may be carried out, for example, by means of a linear regression. Equation (1) merely describes a linear inhomogeneous differential equation of 3rd order as an example. It is conceivable that the linear inhomogeneous differential equation (1) deviates from the degree 3 shown here.

The difference equation may take the form

[symbol]

*yₖ+ [symbol] *yₖ₋₁+ [symbol] *yₖ₋₂+ [symbol] *yₖ₋₃= [symbol] *uₖ+ [symbol] *uₖ₋₁+ [symbol] *uₖ₋₂+ [symbol] *uₖ₋₃ (2)

wherein yₖ, yₖ₋₁, yₖ₋₂, yₖ₋₃ comprise temporally discretised values of the at least one output signal and uₖ, uₖ₋₁, uₖ₋₂, uₖ₋₃ comprise temporally discretised values of the at least one input signal, and wherein [symbol] , [symbol] , [symbol] , [symbol] and [symbol] , [symbol] , [symbol] , [symbol] are the coefficients of the difference equation determined in the determination of the self-identification model. This can be done, for example, by converting the coefficients b₀, b₁, b₂, b₃ and a₀ of the linear inhomogeneous differential equation into the coefficients [symbol] , [symbol] , [symbol] , [symbol] and [symbol] , [symbol] , [symbol] , [symbol] of the difference equation. For example, the publication Lutz, H., u. Wendt, W.: “Taschenbuch der Regelungstechnik”, Frankfurt am Main, 2007: Wissenschaftlicher Verlag Harri Deutsch, reveals from page 540 ff. a transformation method in which the linear inhomogeneous differential equation is transformed into s transfer functions, the corresponding z transfer functions are determined from a z transformation table and the difference equation is determined from this. Equation (2) merely describes a difference equation of 3rd order as an example. It is conceivable that the order of the difference equation (2) deviates from the degree 3 shown here.

It is conceivable that an order of the self-identification equation is increased stepwise, wherein a quality function and/or a quality value is determined, in particular wherein a deviation between the at least one output signal and at least one output signal simulated on the basis of the self-identification equation is determined for determining the quality function and/or the quality value. Thus, a particularly favourable order of the self-identification equation can be determined, in which the behaviour of the machine can be simulated with as little computing power as possible. The order may be the order of the differential equation and/or the difference equation.

In other words, coefficients of the one or more self-identification equations can be determined from the at least one input signal and the at least one output signal when determining the self-identification model. It is also conceivable that a dead time is taken into account. The dead time may include a period of delay of the machine to the input signal. This means, for example, that the machine with dead time does not react immediately to a change in the input signal. The reaction to the change may be delayed by the dead time.

It is conceivable that the self-identification model is used to infer operational changes in the machine and to react to these changes by automatically configuring or optimising the at least one machine parameter and/or automatically carrying out the diagnosis of the machine. This means that the methods can automatically compensate for the changes in the machine caused by operation.

For example, the operational change may comprise a wear, a changed container throughput and/or a changed manipulation mass of the machine, wherein thereby the determined self-identification model changes such that thereupon the at least one machine parameter of the machine and/or of the subsequent machine is automatically adjusted with the changed self-identification model. For example, wear can have a particular effect on a rotation speed and on a position of the containers in the machine and thus on y and \dot{y}. Thus, the coefficients b₁ and b₂ in equation (1) would then be particularly affected. A pattern of change in the coefficients of the self-identification model may thus be used to infer a specific operational change. This makes it possible to react in a particularly targeted manner to operational changes.

The at least one machine parameter may comprise a control parameter, an amount of plastic supplied, an amount of energy, a trajectory, a speed and/or an action time. In other words, the at least one machine parameter may be a setting and/or default for the operation of the machine.

Furthermore, the invention provides a machine for handling containers with the features for solving the object.

The machine may be configured to carry out the method. The machine may comprise the features described previously in relation to the method for operating the machine in the container processing plant.

The fact that the machine with the acquisition unit is configured to acquire the at least one input signal and the at least one output signal of the machine during the processing and/or the transport enables recording them as digital signals. The fact that the machine comprises the self-identification unit for determining the self-identification model of the machine based on the at least one input signal and the at least one output signal, which represents the at least one current operating point of the machine, the real behaviour of the machine at the current operating point can be modelled in the self-identification model. Thus, the self-identification model reflects, for example, wear occurring after commissioning or retooling in a correct manner. By automatically configuring or optimising the at least one machine parameter of the machine and/or the downstream machine using the self-identification model, the current operating point of the machine can be taken into account accordingly. Additionally or alternatively, a diagnosis of the machine may automatically be carried out using the self-identification model. This can be used, for example, to determine whether the wear exceeds a permissible level and a maintenance needs to be carried out.

It is conceivable that the machine comprises a computer system, in particular a machine control system with the acquisition unit and/or the self-identification unit. This allows determining the self-identification model on site in the machine. It is conceivable that the computer system is integrated into the machine or spatially separated from it. For example, the acquisition unit may include an analogue-to-digital converter to acquire analogue signals from sensors. It is conceivable that the machine comprises the sensors to measure the at least one input signal and the at least one output signal. The computer system may comprise a CPU, a memory unit, a network interface, an input unit, an output unit and/or a control unit for controlling the machine. The acquisition unit and/or the self-identification unit may be implemented at least in part as a computer program product comprising machine instructions in the computer system which, when executed, at least partially carry out the method.

### BRIEF DESCRIPTION OF THE DRAWINGS

Further features and advantages of the invention are explained in more detail below with reference to the embodiments shown in the figures, in which:

FIG. 1 shows a flow diagram of an exemplary embodiment of a method for operating a machine in a container processing plant according to the invention;

FIG. 2 shows a side view of an exemplary embodiment of a container making machine according to the invention;

FIG. 3 shows a top view of a further exemplary embodiment of a filler according to the invention;

FIG. 4 shows a side view of a further exemplary embodiment of an autonomous transport vehicle according to the invention; and

FIG. 5 shows a top view of a further exemplary embodiment of a palletiser according to the invention.

### DETAILED DESCRIPTION

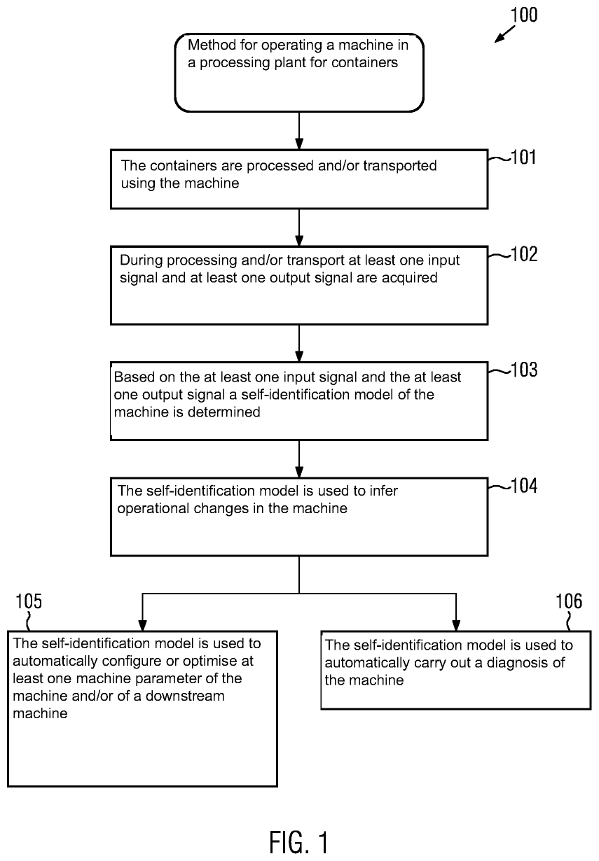

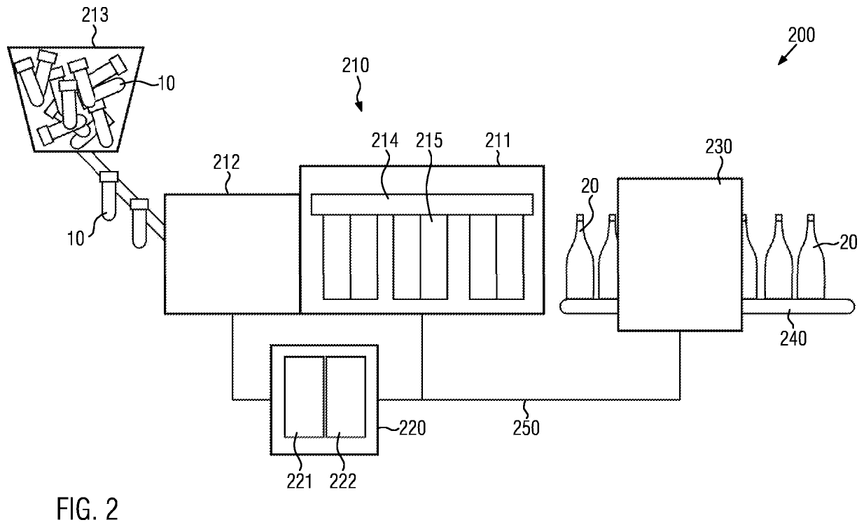

FIG. 1 shows a flow diagram of an exemplary embodiment of a method 100 for operating a machine in a container processing plant according to the invention. The method 100 may be carried out with the machines 200, 300, 400, 500 for handling containers 20 described below with respect to FIGS. 2-5.

In step 101, the containers are processed and/or transported with the machine. As can be seen in FIGS. 2-5, for example, they are produced, filled, transported and/or palletised. It is also conceivable that they are closed, cleaned, labelled, inspected, printed with a direct print, packaged and/or handled with a robot during the processing.

In step 102, at least one input signal and at least one output input signal are acquired during the processing and/or the transport. For example, the at least one input signal may be a control curve of a temporal current curve for a drive of the machine and the at least one output signal may be a measured processing and/or transport speed of the containers.

Subsequently, in step 103, a self-identification model of the machine is determined based on the at least one input signal and the at least one output signal. For this purpose, the self-identification model may comprise one or more self-identification equations, for example a linear inhomogeneous differential equation and/or a difference equation. In determining the self-identification model, coefficients of the one or more self-identification equations are determined from the at least one input signal and the at least one output signal when determining the self-identification model.

For example, the coefficients b₀, b₁, b₂, b₃ and a₀ of the differential equation (1) are determined via a linear regression on the basis of the previously described control curve of the temporal current curve for the drive and from the measured processing and/or transport speed of the containers. It is also conceivable that the coefficients b₀, b₁, b₂, b₃ and a₀ of the differential equation (1) are transformed into the coefficients [symbol] , [symbol] , [symbol] , [symbol] and [symbol] , [symbol] , [symbol] , [symbol] of the difference equation (2). The transfer is carried out with the above mentioned transfer method from the publication Lutz, H., u. Wendt, W.: “Taschenbuch der Regelungstechnik”, Frankfurt am Main, 2007: Wissenschaftlicher Verlag Harri Deutsch from page 540 ff.

A dead time may be taken into account when determining the self-identification model. The dead time of the machine is determined iteratively in the algorithm of self-identification. In an iteration, the at least one measured output signal is shifted in time by a certain dead time. Subsequently, a self-identification model of the machine is identified and the at least one output signal is simulated. By comparing the simulated and the measured output signal or the simulated and the measured output signals, the quality of the model determined for the dead time set in the iteration is calculated. The quality of a model is a measure of the correspondence between the self-identification model and the real machine. The dead time that leads to the self-identification model with the best quality is considered the resulting dead time.

In step 104, the self-identification model is used to infer operational changes in the machine in order to react to these changes by automatically configuring or optimising the at least one machine parameter and/or automatically carrying out the diagnosis of the machine. For example, the operational change may comprise a wear, a changed container throughput and/or a changed manipulation mass of the machine, wherein thereby the determined self-identification model changes such that thereupon the at least one machine parameter of the machine and/or of the subsequent machine is automatically adjusted with the changed self-identification model. For example, wear would cause the actual processing and/or transport speed of the containers to decrease while maintaining the aforementioned control characteristic of the temporal current curve for the drive. This would have a corresponding effect through a change in the coefficients b₀, b₁, b₂, b₃ and a₀ of the differential equation (1). Accordingly, the changed coefficients could then be used to infer the operational change in the machine.

Subsequently, in step 105, the self-identification model is used to automatically configure or optimise at least one machine parameter of the machine and/or a downstream machine. For example, in the case of the previously mentioned wear, the control parameters of a PID control could be adapted in such a way that the control characteristic of the temporal current curve for the drive is converted particularly quickly into the desired processing and/or transport speed of the containers without overshooting.

It is also conceivable that, additionally or alternatively, the diagnosis of the machine is carried out automatically in step 106. For example, if wear is too high, a warning could be issued on a display so that the drive can be serviced or replaced.

FIG. 2 shows a side view of an exemplary embodiment of a container making machine 200 according to the invention. The machine comprises a storage container 213 for the preforms 10, an oven 212 for heating the preforms 10, a stretch blow moulding unit 211 with the conveyor 214 and the stretch blow moulds 215 attached thereto for producing the containers 20 from the preforms 10 during the transport, and a further conveyor 240 for inspecting the finished containers 20 with the inspection unit 230 attached thereto.

Furthermore, the machine control unit 220 can be seen comprising the acquisition unit 221 to acquire the at least one input signal and the at least one output signal of the machine 200 during the processing and the transport. For example, a supplied quantity of plastic, in particular the quantity of preforms 10, may be acquired as the at least one input signal and the bottle quality acquired with the inspection unit 230 may be detected as the at least one output signal. To acquire the at least one input signal and/or the at least one output signal, the machine control unit is connected to the units 211, 212, 230 via the connection lines 250.

Further, it can be seen that the machine control unit 220 comprises the self-identification unit 222 to determine a self-identification model of the machine 200 based on the at least one input signal and the at least one output signal, wherein multiple operating points are reproduced during start-up of the container making machine 200 and then during the ongoing production.

It is conceivable that the self-identification model is used to determine an optimal energy input as a machine parameter for the respective operating points during start-up and ongoing production.

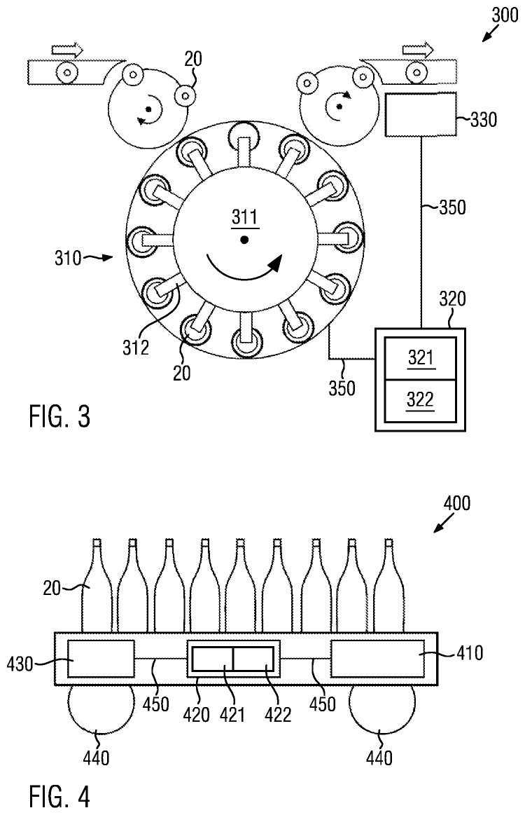

FIG. 3 shows a top view of a further exemplary embodiment of a filler 300 according to the invention. The filler 300 comprises a filling unit 310 with the carousel 311 and the filling valves 312 attached thereto. During the transport, the containers 20 are filled with a flowable product, in particular a drink, using the filling valves 312 and the filling level reached is determined using the inspection unit 330.

It can also be seen that the machine control unit 320 is connected to the filling unit 310 and the inspection unit 330 via the connection lines 350.

The machine control unit 320 further comprises the acquisition unit 321 to acquire pressures in the filling valves 312 as the at least one input signal and the filling level as the at least one output signal.

Furthermore, the machine control unit 320 is configured with the self-identification unit 322 to determine a self-identification model of the filler 300 based on the pressures of the filling valves 312 and the filling levels of the individual containers 20, for example during the ongoing filling operation.

Subsequently, control parameters are optimised using the self-identification model in order to achieve the required filling level particularly quickly.

FIG. 4 shows a side view of a further exemplary embodiment of an autonomous transport vehicle 400 according to the invention. For example, the containers 20 can be transported between two handling stations not shown here. It can be seen that the autonomous transport vehicle comprises a drive unit 410 with which at least some of the wheels 440 are driven. Furthermore, the autonomous transport vehicle 400 comprises a navigation unit 430 in which both a predetermined travel route is stored and corresponding sensors are disposed in order to record the route actually travelled and, for example, the current travel speed.

The figure shows also the machine control unit 420 which is configured with the acquisition unit 421 and the self-identification unit 422.

Using the acquisition unit 421, for example, the predetermined travel route and the actual travel route travelled are acquired as the at least one input signal and as the at least one output signal, respectively. It is conceivable that the drive energy for different travel routes is recorded as operating points.

The self-identification unit 422 determines a self-identification model of the autonomous transport vehicle 400 from the at least one input signal and the at least one output signal, which model reproduces the different operating points of the machine.

The self-identification unit is also configured to use the self-identification model to optimise control parameters for the control of the drive unit 410 in such a way that an optimum use of energy and a minimum deviation between the predefined and travelled travel route is possible for the different operating points.

It is also conceivable that the self-identification model is used to carry out a diagnosis of the autonomous vehicle 400, for example, the self-identification model may be used to infer the wear of the drive unit 410.

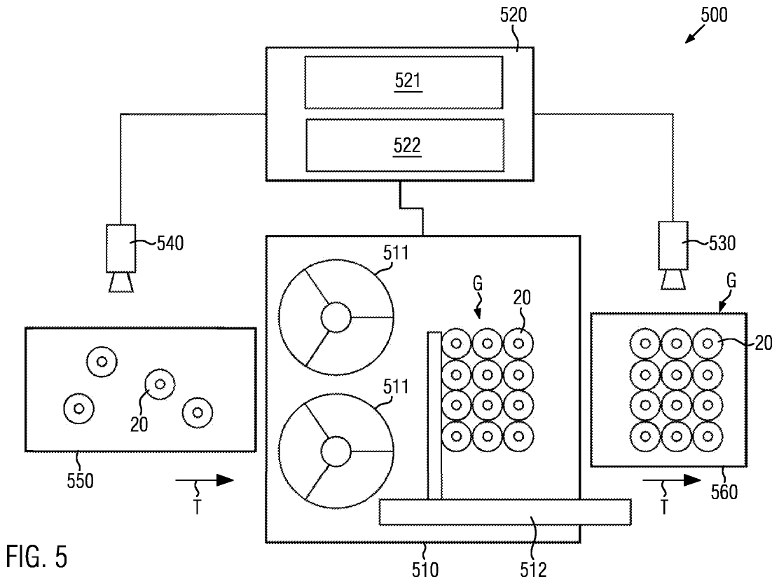

FIG. 5 shows a top view of a further exemplary embodiment of a palletiser 500 according to the invention. It can be seen that the containers 20 are first fed by a first conveyor 550 in transport direction T to a sorting table 510 in order to arrange the containers 20 in groups G there. For this purpose, the positions of the initially disordered containers 20 are recorded with the camera unit 540. The containers 20 are then picked up by the robots 511 and assembled in the group G. They are thus grouped and pushed onto the second conveyor 560 by the pusher 512. There, the correct grouping is then inspected with another camera 530.

Furthermore, the machine control unit 520 with the detection unit 521 is shown, with which, for example, the number and arrangement of the disordered containers 20 on the first conveyor 550 are detected as the at least one input signal and the arrangement reached in the group G on the second conveyor 560 is detected as the at least one output signal.

Subsequently, the self-identification unit 522 of the machine control unit 520 is used to determine a self-identification model of the packaging machine 500 that represents the different operating points for different processing quantities.

Furthermore, the self-identification unit 522 of the machine control 520 is configured to automatically optimise the control parameters of the robots 511 in order to avoid unnecessary braking and acceleration operations at the different operating points.

The fact that, in the method 100 and the machines 200, 300, 400, 500 according to the embodiments described above, the at least one input signal and the at least one output signal of the machine 200, 300, 400, 500 are acquired during the processing and/or the transport and, based thereon, the self-identification model of the machine 200, 300, 400, 500 is determined, which model reproduces the at least one current operating point of the machine 200, 300, 400, 500, enables reproducing the real behaviour of the machine 200, 300, 400, 500 in the self-identification model. Thus, the self-identification model reflects the behaviour accordingly. By automatically configuring or optimising the at least one machine parameter of the machine 200, 300, 400, 500 using the self-identification model, the current operating point of the machine 200, 300, 400, 500 can be taken into account accordingly. Additionally or alternatively, a diagnosis of the machine 200, 300, 400, 500 may automatically be carried out using the self-identification model. This can be used, for example, to determine whether the wear exceeds a permissible level and a maintenance needs to be carried out. Thus, the method 100 and the machines 200, 300, 400, 500 work particularly efficiently and reliably.

It is understood that features mentioned in the previously described exemplary embodiments are not limited to this combination of features but are also possible individually or in any other combination.

1-10. (canceled)

11. A method for operating a machine in a processing plant for containers, including beverage containers, wherein the containers are processed and/or transported by the machine, the method comprising:
acquiring at least one input signal and at least one output signal of the machine during the processing and/or the transport;
determining a self-identification model of the machine based on the at least one input signal and the at least one output signal, wherein the self-identification model reproduces at least one current operating point of the machine;
automatically configuring or optimising, using the self-identification model, at least one machine parameter of the machine and/or of a downstream machine; and
automatically performing, using the self-identification model, a diagnosis of the machine.

12. The method of claim 11, wherein the self-identification model is continuously determined during operation of the machine.

13. The method of claim 11, wherein the self-identification model comprises one or more self-identification equations, including a linear inhomogeneous differential equation and/or a difference equation.

14. The method of claim 13, further comprising determining coefficients of the one or more self-identification equations from the at least one input signal and the at least one output signal when determining the self-identification model.

15. The method of claim 13, wherein a dead time is used when determining the self-identification model.

16. The method of claim 11, further comprising inferring, using the self-identification model, operational changes in the machine to respond thereto by automatically configuring or optimising the at least one machine parameter and/or automatically diagnosing the machine.

17. The method of claim 16, wherein the operational changes comprises a wear, a changed container throughput, and/or a changed manipulation mass of the machine, further comprising:
changing the determined self-identification model such that the at least one machine parameter of the machine and/or of the downstream machine is automatically adjusted with the changed self-identification model.

18. The method of claim 11, wherein the at least one machine parameter comprises a control parameter, an amount of plastic supplied, an amount of energy, a trajectory, a speed and/or an action time.

19. The method of claim 11, wherein the machine comprises a container making machine, a filler, a capper, a rinser, a labeller, a container inspection machine, a direct printing machine, a conveyor, a palletiser, a packaging machine, a robot, an autonomous transport vehicle, and/or a pump.

20. A machine for handling containers, including beverage containers, wherein the machine is configured for processing with a processing unit and/or for transporting the containers with a transport unit, the machine comprising:
an acquisition unit configured to acquire at least one input signal and at least one output signal of the machine during the processing and/or the transport, and
a self-identification unit configured to determine a self-identification model of the machine based on the at least one input signal and the at least one output signal, wherein the self-identification model reproduces at least one current operating point of the machine,
wherein the self-identification unit is configured to:
automatically configure or optimise at least one machine parameter of the machine and/or of a downstream machine using the self-identification model; and
automatically perform a diagnosis of the machine using the self-identification model.

21. The machine of claim 20, wherein the self-identification model is continuously determined during operation of the machine.

22. The machine of claim 20, wherein the self-identification model comprises one or more self-identification equations, including a linear inhomogeneous differential equation and/or a difference equation.

23. The machine of claim 22, wherein, to determine the self-identification model, the self-identification unit is further configured to determine coefficients of the one or more self-identification equations from the at least one input signal and the at least one output signal.

24. The machine of claim 22, wherein a dead time is used when determining the self-identification model.

25. The machine of claim 20, wherein the self-identification model is configured to infer operational changes in the machine and, to respond thereto, is configured to automatically configure or optimise the at least one machine parameter and/or automatically diagnose the machine.

26. The machine of claim 25, wherein the operational changes comprises a wear, a changed container throughput, and/or a changed manipulation mass of the machine, and wherein the self-identification model is changed such that the at least one machine parameter of the machine and/or of the downstream machine is automatically adjusted with the changed self-identification model.

27. The machine of claim 20, wherein the at least one machine parameter comprises a control parameter, an amount of plastic supplied, an amount of energy, a trajectory, a speed and/or an action time.

28. The machine of claim 20, wherein the machine comprises a container making machine, a filler, a capper, a rinser, a labeller, a container inspection machine, a direct printing machine, a conveyor, a palletiser, a packaging machine, a robot, an autonomous transport vehicle, and/or a pump.
